(19) United States
(12) Patent Application Publication
(10) Pub. No.: US 2016/0103855 A1
(43) Pub. Date: Apr. 14, 2016

(54) COLLABORATIVE ITEM DATABASE

(71) Applicant: LENOVO (Singapore) PTE, LTD., New Tech Park (SG)

(72) Inventors: Rod D. Waltermann, Rougemont, NC (US); John Carl Mese, Cary, NC (US); Nathan J. Peterson, Durham, NC (US); Russell Speight VanBlon, Raleigh, NC (US); Arnold S. Weksler, Raleigh, NC (US)

(21) Appl. No.: 14/509,968

(22) Filed: Oct. 8, 2014

(51) Int. Cl. G06F 17/30; G06Q 30/06

(52) U.S. Cl. CPC G06F 17/30289; G06Q 30/0623

(57) ABSTRACT

For aggregating items in a collaborative item database, an apparatus includes one or more servers. Each server includes a processor and a memory that stores code executable by the processor. The code generates first item data that includes a first item identifier and a first item location from environment data received from a first ubiquitous computer. The code further aggregates the first item data in the collaborative item database. The collaborative item database includes item data from a plurality of ubiquitous computers.

### FIELD

The subject matter disclosed herein relates to a database and more particularly relates to a collaborative item database.

### BACKGROUND

Description of the Related Art

Items are often available for sale that are not discoverable through a search engine or a retailer's database

### BRIEF SUMMARY

An apparatus for aggregating a collaborative item database, herein referred to as a collaborative database, is disclosed. The apparatus includes one or more servers. Each server includes a processor and a memory that stores code executable by the processor. The code generates first item data that includes a first item identifier and a first item location from environment data received from a first ubiquitous computer. The code further aggregates the first item data in the collaborative database. The collaborative database includes item data from a plurality of ubiquitous computers. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a collaborative database system;

FIG. 1B is a perspective drawing illustrating one embodiment of a retail entity;

FIG. 2A is a schematic block diagram illustrating one embodiment of environment data;

FIG. 2B is a schematic block diagram illustrating one embodiment of a request query;

FIG. 2C is a schematic block diagram illustrating one embodiment of item data;

FIG. 3 is a schematic block diagram illustrating one embodiment of a server;

FIG. 4A is a schematic flow chart diagram illustrating one embodiment of an item data aggregation method; and

FIG. 4B is a schematic flow chart diagram illustrating one embodiment of an item data retrieval method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

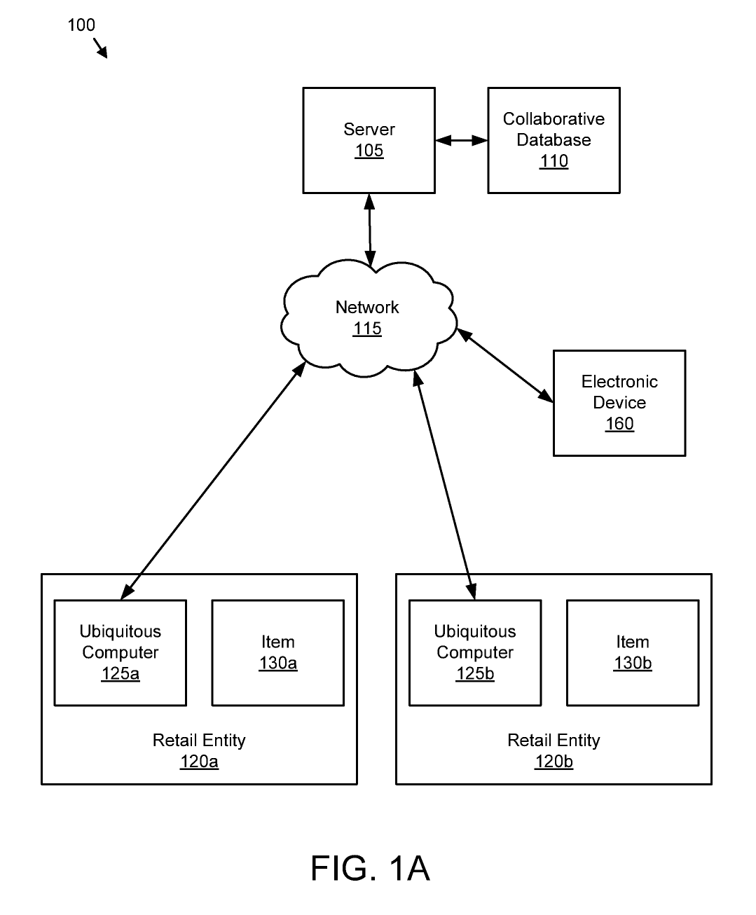

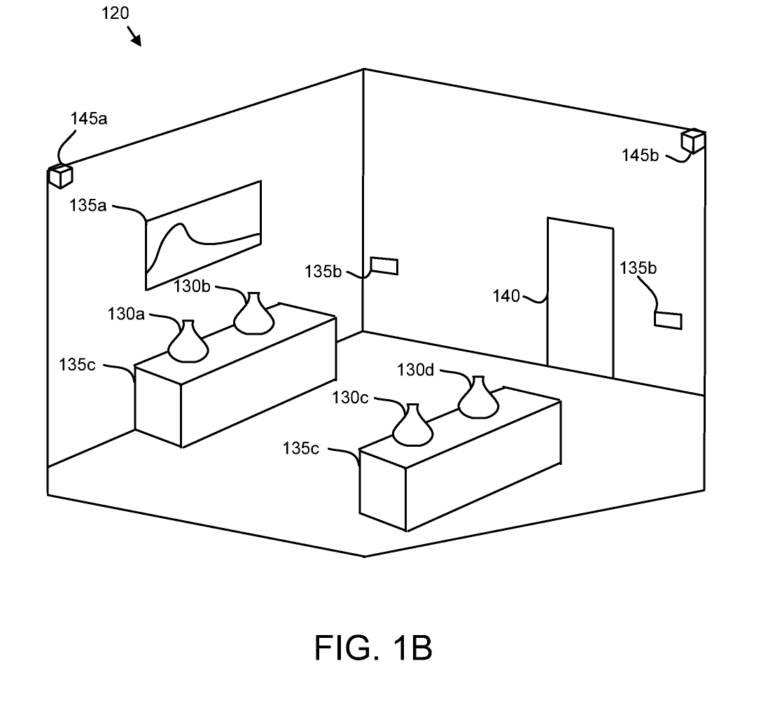

FIG. 1A is a schematic block diagram illustrating one embodiment of a collaborative database system 100. In the depicted embodiment, the system 100 includes one or more servers 105, a collaborative database 110, a network 115, and one or more ubiquitous computers 125.

In the past, a consumer desiring to purchase an item was limited to information provided by retailers such as through advertisements, online inventory databases, the investigations of retail personnel, and search engines. However, many items are available that are not discoverable through these means. In addition, items at a retailer may be available when not discoverable through the retailer's inventory database or retail personnel.

The embodiments described herein aggregate item data in the collaborative database 110. The collaborative database 110 may be independent of retail databases and so may allow a consumer to discover items 130 that are not discoverable in the retail databases or other traditional sources of information as will be described hereafter.

The network 115 may be the Internet, a mobile telephone network, a wireless network, a wide-area network, a local area network, or combinations thereof. The server 105 may be a single server 105 or a plurality of servers 105 in a server farm. The ubiquitous computer 125 may be a wearable computer, a mobile telephone, a wearable camera, a tablet computer, or the like. The wearable computer may be an eyeglass computer, a computer disposed in clothing, a computer disposed on a wrist, or the like.

The ubiquitous computer 125 may record environment data at a retail entity 120. The retail entity 120 may be a store. Alternatively, the retail entity 120 may be an informal venue including but not limited to a garage sale, a swap meet, and items in public view. For example, a particular make and model of car may be displayed in public with an offer for sale.

The retail entity 120 may include one or more items 130. The ubiquitous computer 125 may record environment data with details of the items 130. In one embodiment, the environment data is periodically and autonomously recorded by a ubiquitous computer 125. The environment data may be recorded by the ubiquitous computer 125 each sample time interval. In one embodiment, the sample time interval is in the range of 1 to 15 seconds.

Alternatively, the environment data may be recorded by the ubiquitous computer 125 each sample distance interval. The environment data may be recorded each time the sample distance interval is traversed. The sample distance interval may be a function of ubiquitous computer's rate of travel. For example, the sample distance interval may be in the range of 1 to 3 meters for ubiquitous computer 125 traveling in the range of 0.5 to 2 meters per second. In addition, the sample distance interval may be in the range of 10 to 30 meters for ubiquitous computer 125 traveling in the range of 4 to 30 meters per second.

The ubiquitous computer 125 may communicate the environment data through the network 115 to the server 105. The server 105 may receive the environment data from the plurality of ubiquitous computers 125.

In addition, the server 105 may generate item data from the environment data and aggregate the item data in the collaborative database 110. The collaborative database 110 maybe organized as a database structure stored on a memory of the server 105 and/or on a storage device in communication with the server 105. The collaborative database 110 may be searched using an electronic device 160 to find a desired item 130.

FIG. 1B is a perspective drawing illustrating one embodiment of a retail entity 120. For illustrative purposes, the complexity of a typical retail entity 120 has been simplified. In the depicted embodiment, the retail entity 120 includes a plurality of items 130. The items 130 may be for sale. Alternatively, the items 130 may be potentially for sale.

The retail entity 120 includes a plurality of landmarks 135. The landmarks 135 may include graphic art 135a, shelving 135c, aisles, signage 135b, and the like. In addition, the retail entity 120 may include an entry location 140. In one embodiment, the retail entity 120 includes one or more wireless transmitters 145 such as Wi-Fi transmitters.

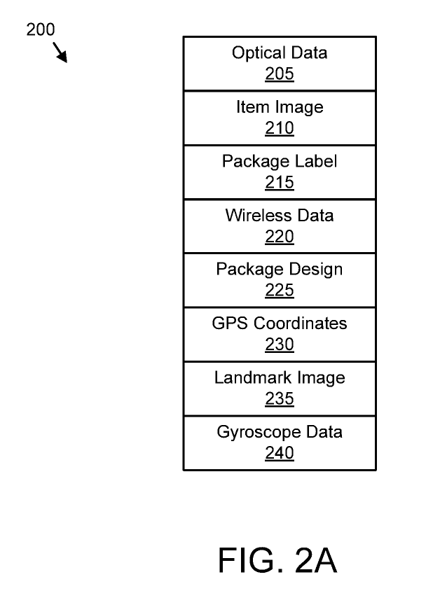

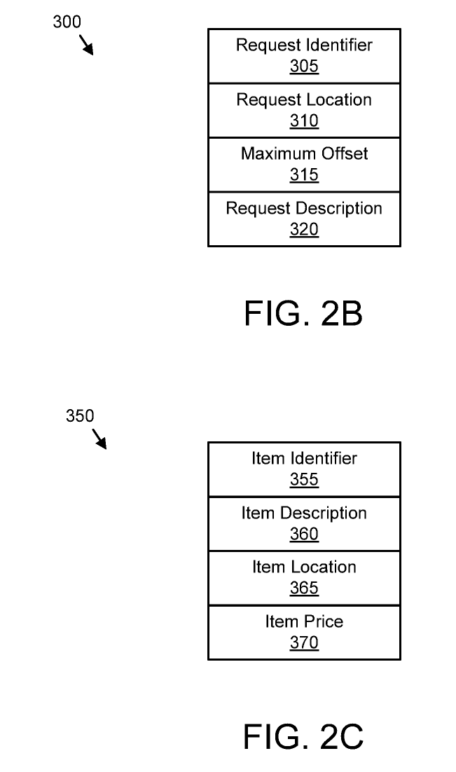

FIG. 2A is a schematic block diagram illustrating one embodiment of environment data 200. The environment data 200 may be communicated from a ubiquitous computer 125 to the server 105. The environment data 200 maybe organized as a data structure and may be stored in a memory of the server 105, a memory of the ubiquitous computer 125, or combinations thereof. Elements of the environment data 200 may be generated from other elements of the environment data 200 by the server 105 and/or by the ubiquitous computer 125.

In the depicted embodiment, the environment data 200 includes optical data 205, an item image 210, a package label 215, wireless data 220, a package design 225, a global positioning system coordinate 230, a landmark image 235, and gyroscope data 240.

In one embodiment, the optical data 205 is captured when the environment data 200 is recorded. For example, the optical data 205 may be sampled from a video stream each time the environment data 200 is recorded. In one embodiment, the optical data 205 is a series of video images sampled between recordings of the environment data 200.

In one embodiment, the optical data 205 is captured each time a new scene is in the field of view of the ubiquitous device 125. For example, the ubiquitous device 125 may recognize and track items 130 within a field of view. When first items 130 are replaced with second items 130 in the field of view, the optical data 205 may be captured. Alternatively, ubiquitous device 125 may track the fields of view. Each time the current field of view includes a space that has not previously been captured as optical data 205, the ubiquitous device 125 may capture the optical data 205 from the current field of view. In one embodiment, the optical data 205 is captured each time the current field of view includes an un-captured space in the range of 10 to 35 percent of the current field of view.

The item image 210 may be parsed from the optical data 205. The item image 210 may be parsed by the server 105. Alternatively, the item image 210 may be parsed by the ubiquitous computer 125. In one embodiment, the item image 210 is parsed from the optical data 205 using a template to identify the item image 210. For example, a template of a box may be used to identify a packaged item 130. Alternatively, a template of a bicycle may be used to identify a bicycle item 130.

The package label 215 may be parsed from the item image 210. The package label 215 may be parsed by the server 105 and/or the ubiquitous computer 125. In one embodiment, text, optical codes, trade dress, and the like are identified in the item image 210 and may be recorded as the package label 215. In one embodiment, the package label 215 includes a character representation of the text and optical codes using Unicode characters, ASCII characters, or the like.

The wireless data 220 may include radio frequency identifier (RFID) data, near field communication (NFC) data, Bluetooth data, Wi-Fi network data, and the like. For example, the ubiquitous computer 125 may record the RFID data and/or the NFC data from one or more items 130 in the retail entity 120. In addition, the ubiquitous computer 125 may record the Bluetooth data and/or the Wi-Fi network data at various locations within the retail entity 120.

The package design 225 may be parsed from the item image 210. The package design 225 may be parsed by the server 105 and/or by ubiquitous computer 125. The package design 225 may include dimensions of packaging for the item 130, graphic designs for the packaging of the item 130, colors of the packaging for the item 130, and the like.

The GPS coordinates 230 may be recorded for one or more locations. In one embodiment, the GPS coordinates 230 are for an entry location 140 of the retail entity 120. Alternatively, the GPS coordinates 230 may be a last GPS coordinate 230 before entering the retail entity 120.

The landmark image 235 may be parsed from the optical data 205. The server 105 and/or the ubiquitous computer 125 may parse the landmark image 235 from the optical data 205. In one embodiment, the landmark image 235 includes character text of any text and/or codes in the landmark image 235. The landmark image 235 may include distinctive elements such as artwork, graphics, and/or signage.

The gyroscope data 240 may be recorded by the ubiquitous computer 125. In one embodiment, the gyroscope data 240 is recorded from a last GPS coordinate 230. The gyroscope data 240 may be used to determine a location of an item 130 using dead reckoning navigation.

FIG. 2B is a schematic block diagram illustrating one embodiment of a request query 300. The request query 300 may be organized as a data structure. The request query 300 may be communicated to the collaborative database 110 in order to discover a desired item 130 that is described by the request query 300. In the depicted embodiment, the request query 300 includes a request identifier 305, a request location 310, a maximum offset 315, and request description 320.

The request identifier 305 identifies a desired item 130. The request identifier may be a shopkeeper's unit (SKU), a model number, a product name, a product code, or combinations thereof. For example, the request identifier 305 may be the product name of the desired item 130.

The request location 310 may be the location from which the desired item 130 is sought. For example, the request location 130 may be a location the electronic device 160. Alternatively, the request location 130 may be an address of the consumer using the electronic device 160. The request location 130 may be GPS coordinates, a postal code, an address, or combinations thereof.

In addition, the request location 130 may specify transportation means that are available to a consumer. For example, the request location 130 may specify that the consumer will travel to the desired item 130 by public transportation. Alternatively, the request location may specify that the consumer will travel to the desired item 130 using an automobile. In one embodiment, the request location 130 may specify that the consumer will walk to the desired item 130.

The maximum offset 315 may be an offset selected from the group consisting of a store, a shopping center, a travel time, a travel method, and a distance. The maximum offset 315 may limit a search for a desired item 130 relative to the request location 310. For example, if the maximum offset 315 is a store, the search for the desired item 130 may be limited to within a store where the electronic device 160 is located. Similarly, if the maximum offset 315 is a shopping center, the search for the desired item 130 may be limited to within the shopping center where the electronic device 160 is located.

If the maximum offset 315 is a travel time, the search for the desired item 130 may be limited to locations that can be reached from the request location 310 using the specified transportation means within the travel time maximum offset 315. For example, the request location 310 may be the consumer's home and may specify transportation means of an automobile. The maximum offset may be a 30 minute travel time. The search for the desired item 130 may be limited to items 130 located within 30 minutes automobile travel time of the consumer's home.

The request description 320 may describe characteristics of the desired item 130. In one embodiment, the request description 320 includes descriptive elements not included in the request item 305. The request description 320 may include a common name for the desired item 130, an image of the desired item 130, distinguishing characteristics of the desired item 130, and the like. The request description 320 may be used to identify the desired item 130 when an SKU, product code, and/or product name for the desired item 130 is unavailable as will be described hereafter.

FIG. 2C is a schematic block diagram illustrating one embodiment of item data 350. The item data 350 may be generated from the environment data 200. The item data 350 maybe organized as an entry in the collaborative database 110. In the depicted embodiment, the item data 350 includes an item identifier 355, an item description 360, an item location 265, and an item price 270.

The item identifier 355 may be an SKU, a product code, and/or a product name that is generated from the environment data 200. For example, the item image 210 may include a characteristic selected from the group consisting of an optical code, an item image 210, a package label 215, and a package design 225. The item identifier 355 may be generated from the characteristic. Alternatively, the wireless data 220 may include a wireless code encoding an SKU. The item identifier 355 may be generated from the wireless code. In one embodiment, the item identifier 355 is an index to the item data 350 in the collaborative database 110.

The item description 360 may describe characteristics of the item 130. In one embodiment, the item description 360 includes descriptive elements not included in the item identifier 355. The item description 360 may include a common name for the item 130, an image of the item image 210, distinguishing characteristics of the item 130, and the like.

The item location 365 may describe the location of the item 130. The item location 365 may include one or more of the GPS coordinates 230, an address determined from the GPS coordinates 230, and/or directions to the item 130. In one embodiment, the item location 365 is generated from a location selected from the group consisting of wireless network triangulation, dead reckoning positioning, optical location recognition, and the GPS coordinate 230.

For example, the item location 365 may be generated using wireless network triangulation between the wireless transmitters 145 within the retail entity 120. In one embodiment, wireless network triangulation is used to determine the item location 365 relative to the entry location 140.

Alternatively, the item location 365 may be generated using dead reckoning position. The gyroscope data 240 may be used to determine a dead reckoning position relative to a last GPS coordinate 230. Alternatively, the gyroscope data 240 may be used to determine a dead reckoning position relative to the entry location 140.

In one embodiment, the item location 365 is generated using optical location recognition. One or more landmarks 135 may be identified from one or more landmark images 235. The item location 365 may be generated from the landmarks 135. In one embodiment, a landmark 135 nearest to the item 130 is included in the item location 365. Alternatively, the directions to the item 130 include one or more landmark images 235. The landmark images 235 may be organized sequentially to lead a consumer from an entry location 140 to the item 130.

Alternatively, the directions to the item may include a dead reckoning position from the entry location 140 based on the gyroscope data 240. For example, the directions may include a heading and a distance from the entry location 140.

The item price 370 may be generated from the item image 210 and/or the wireless data 220. The item price 370 may be generated from a price tag affixed to the item 130 in the item image 210. Alternatively, the item price 370 may be generated from a price tag associated with the item 130, such as placed adjacent to the item 130, in the item image 210. In one embodiment, the item price 370 is generated by using the item identifier 355 to retrieve the item price 370 from a retailer database.

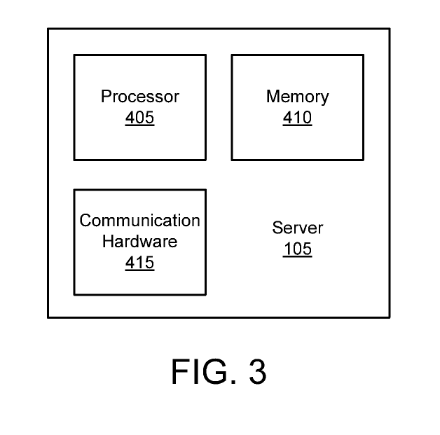

FIG. 3 is a schematic block diagram illustrating one embodiment of a server 105. In the depicted embodiment, the server 105 includes at least one processor 405, a memory 410, and communication hardware 415. The memory 410 may be a semiconductor memory device, a hard disk drive, an optical storage device, a micromechanical storage device, or combinations thereof. The memory 410 may store code. The processor 405 may execute the code. In addition, the memory 410 may store the collaborative database 110.

The communication hardware 415 may communicate with other devices such as the network 415. In addition, the communication hardware 415 may communicate with a storage device storing the collaborative database 110.

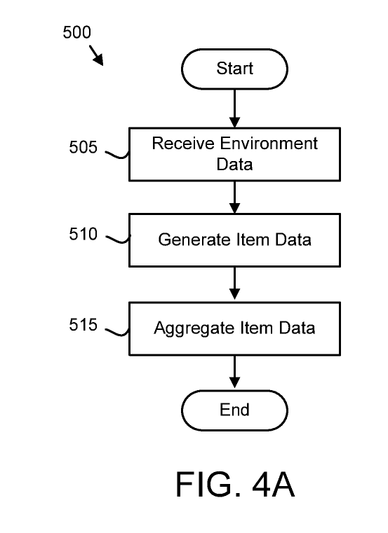

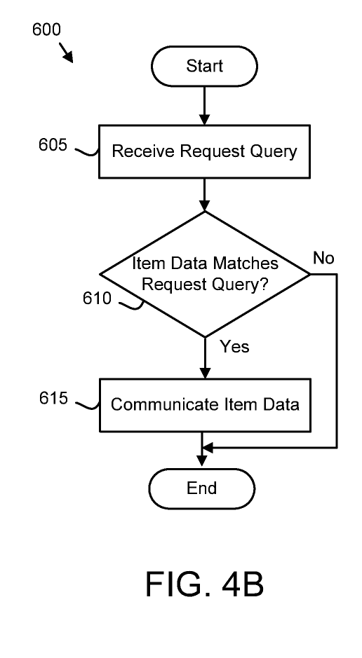

FIG. 4A is a schematic flow chart diagram illustrating one embodiment of an item data aggregation method 500. The method 500 may generate the item data 350 from the environment data 200 and aggregate the item data 350 in the collaborative database 110. The method 500 may be performed by a processor 405. Alternatively, the method 500 may be performed by a computer readable storage medium such as the memory 410. The computer readable storage medium may store code that when executed by the processor 405 performs the method 500.

The method 500 starts, and in one embodiment, the server 105 receives 505 the environment data 200 from a first ubiquitous computer 125. The ubiquitous computer 125 may periodically and/or autonomously record the environment data 200. In addition, the ubiquitous computer 125 may record and transmit the environment data 200 to the server 105 each sample time interval.

The server 105 may further generate 510 the item data 350 from the environment data 200. In one embodiment, the server 105 parses the item image 210 from the optical data 205. The server 105 may further parse a package label 215 and/or a package design 225 from the item image 210. The server 105 may further generate 510 the item identifier 355 from the package label 215 and/or the package design 225. The item identifier 355 may be generated from a characteristic selected from the group consisting of an optical code, an item image, a package label, and a package design. In one embodiment, the item identifier 355 is an SKU, product code, and/or product name that is generated from the package label 215. Alternatively, the item identifier 355 is generated by comparing the package design 225 with the database of known product packages. If a known product package matches the package design 225, the item identifier 355 may be an identifier of the known product package.

Alternatively, the server 105 may identify a wireless code from the wireless data 220. The wireless code may be an SKU, a product code, and/or a product name. The server 105 may record the wireless code as the item identifier 355.

The server 105 may further generate 510 the item description 360 from the item image 210. In one embodiment, a common name for the item 130 is recognized from the item image 210. In addition, one or more colors of the item 130 may be recognized from the item image 210. The common name and/or the colors may be recorded as the item description 360.

In one embodiment, the server 105 generates 510 the item location 365 from the environment data 220. The server 105 may employ one or more of wireless network triangulation, dead reckoning positioning, optical location recognition, and/or the GPS coordinate 230 to generate the item location 365.

In addition, the server 105 may generate 510 the item price 370 from the environment data 220. The server 105 may generate 510 the item price 370 from the item image 210 and/or the wireless data 220. The item price 370 may be generated from a price tag affixed to the item 130 in the item image 210. Alternatively, the item price 370 may be generated from a price tag associated with the item 130, such as placed adjacent to the item 130, in the item image 210. In one embodiment, the item price 370 is generated by using the item identifier 355 to retrieve the item price 370 from a retailer database.

The server 105 may aggregate 515 the item data 350 into the collaborative database 110 and the method 500 ends. In one embodiment, the server 105 may compare the item data 350 to other item data entries and remove older duplicate entries. The collaborative database 110 may be available for discovering desired items 130.

FIG. 4B is a schematic flow chart diagram illustrating one embodiment of an item data retrieval method 600. The method 600 retrieves the item data 350 for a desired item 130 from the collaborative database 110. The method 600 may be performed by a processor 405. Alternatively, the method 600 may be performed by a computer readable storage medium such as the memory 410. The computer readable storage medium may store code that when executed by the processor 405 performs the method 600.

The method 600 starts, and in one embodiment, the server 105 receives 605 a request query 300. The request query 300 may be received from an electronic device 160. In addition, the request query 300 may describe a desired item 130.

The server 105 determines 610 if item data 350 in the collaborative database 110 matches the request query 300. In one embodiment, the item data 350 matches the request query 300 in response to a request location 310 being within the maximum offset 315 of the item location 365. For example, if the maximum offset 315 is a shopping center, the item data 350 matches the request query 300 if the item location 365 is a within the shopping center where the electronic device 160 is located.

In one embodiment, the item data 350 matches the request query 300 if the item identifier 355 is equivalent to the request identifier 305. In addition, the item data 350 may match the request query 300 if the item description 360 satisfies the minimum portion of the request query 300.

In one embodiment, the item description 360 satisfies a minimum portion of the request query 300 if the comparison of the request description 320 and the item description 360 exceeds an equivalence threshold. The equivalence threshold may be calculated as a weighted sum of each descriptive phrase that is used in both the request description 320 and the item description 360. In one embodiment, non-descriptive phrases are not considered.

If the item data 350 does not matches the request query 300, the method 600 ends. If the item data 350 matches the request query 300, the server 105 may communicate 615 the item data 350 to the electronic device 160 and the method 600 ends. In one embodiment, the server may communicate 615 item data 350 for multiple items 130 matching the request query 300.

The embodiments generate the item data 350 from the environment data 200 that is captured by ubiquitous computers 125. The item data 350 is aggregated to the collaborative database 110 so that desired items 130 may be discovered from a single source and when those desired items 130 are not otherwise electronically discoverable.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
one or more servers hosting a collaborative database, each server comprising:
a processor;
a memory that stores code executable by the processor, the code comprising:
code that generates first item data comprising a first item identifier and a first item location from environment data received from a first ubiquitous computer; and
code that aggregates the first item data in the collaborative database, wherein the collaborative database comprises item data from a plurality of ubiquitous computers.

2. The apparatus of claim 1, wherein the environment data comprises an item image and the first item identifier is generated from a characteristic selected from the group consisting of an optical code, an item image, a package label, and a package design.

3. The apparatus of claim 1, wherein the environment data comprises wireless data and the first item identifier is generated from a wireless code.

4. The apparatus of claim 1, wherein the item location is generated from a location selected from the group consisting of wireless network triangulation, dead reckoning positioning, optical location recognition, and a global positioning system (GPS) coordinate.

5. The apparatus of claim 1, wherein the environment data is periodically, autonomously recorded at the first ubiquitous computer each sample time interval.

6. The apparatus of claim 1, the code further comprising code that communicates the first item data in response to first item data matching a request query.

7. The apparatus of claim 6, wherein the first item data matches the request query in response to a request location being within a maximum offset of the first item location.

8. The apparatus of claim 7, wherein the maximum offset is an offset selected from the group consisting of a store, a shopping center, a travel time, a travel method, and a distance.

9. The apparatus of claim 6, wherein the first item data further comprises a first item description and wherein the first item data matches the request query in response the first item description satisfying a minimum portion of the request query.

10. A method comprising:
generating, by use of a processor, first item data comprising a first item identifier and a first item location from environment data received from a first ubiquitous computer; and
aggregating the first item data in a collaborative database, wherein the collaborative database comprises item data from a plurality of ubiquitous computers.

11. The method of claim 10, wherein the environment data comprises an item image and the first item identifier is generated from a characteristic selected from the group consisting of an optical code, an item image, a package label, and a package design.

12. The method of claim 10, wherein the environment data comprises wireless data and the first item identifier is generated from a wireless code.

13. The method of claim 10, wherein the item location is generated from a location selected from the group consisting of wireless network triangulation, dead reckoning positioning, optical location recognition, and a global positioning system (GPS) coordinate.

14. The method of claim 10, wherein the environment data is periodically, autonomously recorded at the first ubiquitous computer each sample time interval.

15. The method of claim 10, the method further communicating the first item data in response to first item data matching a request query.

16. The method of claim 15, wherein the first item data matches the request query in response to a request location being within a maximum offset of the first item location.

17. The method of claim 16, wherein the maximum offset is an offset selected from the group consisting of a store, a shopping center, a travel time, a travel method, and a distance.

18. The method of claim 15, wherein the first item data further comprises a first item description and wherein the first item data matches the request query in response the first item description satisfying a minimum portion of the request query.

19. A program product comprising a computer readable storage medium that stores code executable by a processor, the executable code comprising code to perform:
generating first item data comprising a first item identifier and a first item location from environment data received from a first ubiquitous computer; and
aggregating the first item data in a collaborative database, wherein the collaborative database comprises item data from a plurality of ubiquitous computers.

20. The program product of claim 19, wherein environment data comprises one or more of an item image and wireless data and the item identifier is generated from one or more of an optical code, an item image, a package label, a package design, and a wireless code.
